(19) United States
(12) Patent Application Publication
(10) Pub. No.: US 2025/0037270 A1
(43) Pub. Date: Jan. 30, 2025

(54) SYSTEMS AND METHODS FOR MAPPING COATINGS TO A SPATIAL APPEARANCE SPACE

(71) Applicant: PPG Industries Ohio, Inc., Cleveland, OH (US)

(72) Inventors: Anthony J. Foderaro, Parma, OH (US); Allison M. Norris, Gibsonia, PA (US)

(21) Appl. No.: 18/912,418

(22) Filed: Oct. 10, 2024

Related U.S. Application Data
(63) Continuation of application No. 17/753,640, filed on Mar. 10, 2022, now Pat. No. 12,148,146.
(60) Provisional application No. 62/902,520, filed on Sep. 19, 2019.

(51) Int. Cl. G06T 7/00; G06T 7/40; G06T 7/70; G06T 7/90; G06V 10/60; G06V 10/74

(52) U.S. Cl. CPC G06T 7/001; G06T 7/40; G06T 7/70; G06T 7/90; G06V 10/60; G06V 10/74; G06T 2200/24; G06T 2207/10024; G06T 2207/30156

(57) ABSTRACT

A computer system for mapping coatings to a spatial appearance space may receive coating spatial appearance variables of a target coating from a coating-measurement instrument. The computer system may generate spatial appearance space coordinates for the target coating by mapping each of the coating spatial appearance variables to an individual axis of a multidimensional coordinate system. The computer system may identify particular spatial appearance space coordinates from the identified spatial appearance space coordinates associated with the potentially matching reference coatings that are associated with a smallest spatial-appearance-space distance from the spatial appearance space coordinates of the target coating. Further, the computer system may display a visual interface element indicating a particular reference coating that is associated with the particular spatial appearance space coordinates as a proposed spatial appearance match to the target coating.

### CROSS-REFERENCE TO RELATED APPLICATIONS

This application is a continuation of U.S. patent application Ser. No. 17/753,640 filed on Mar. 10, 2022, and entitled” SYSTEMS AND METHODS FOR MAPPING COATINGS TO A SPATIAL APPEARANCE SPACE,” which application is a National Stage Entry of PCT/US2020/051487 filed on Sep. 18, 2020, and entitled” SYSTEMS AND METHODS FOR MAPPING COATINGS TO A SPATIAL APPEARANCE SPACE,” which claims the benefit of and priority to U.S. Provisional Patent Application Ser. No. 62/902,520 filed on 19 Sep. 2019 and entitled “SYSTEMS AND METHODS FOR MAPPING COATINGS TO A SPATIAL APPEARANCE SPACE.” Each of the aforementioned applications is incorporated herein by references in their entirety.

### TECHNICAL FIELD

The present invention relates to computer-implemented methods and systems for aiding in identifying matching coatings to a target coating, particularly by mapping coatings to a spatial appearance space, and related computer program products.

### BACKGROUND

Modern coatings provide several important functions in industry and society. Coatings can protect a coated material from corrosion, such as rust. Coatings can also provide an aesthetic function by providing a particular color and/or spatial appearance to an object. For example, most automobiles are coated using paints and various other coatings in order to protect the metal body of the automobile from the elements and also to provide aesthetic visual effects.

In view of the wide-ranging uses for different coatings, it is often necessary to identify a target coating composition. For instance, it might be necessary to identify a target coating on an automobile that has been in an accident. If the target coating is not properly identified, any resulting repair to the automobile's coating will not match the original coating. As used herein, a target coating comprises any coating of interest that has been applied to any physical object.

There are many opportunities for new methods and systems that improve the identification of coatings.

### BRIEF SUMMARY OF THE INVENTION

The present invention relates to a computerized method for use on a computer system comprising one or more processors and one or more computer-readable media having stored thereon executable instructions that when executed by the one or more processors configure the computer system to perform a method for mapping coatings to a spatial appearance space. The computerized method comprises receiving a plurality of coating spatial appearance variables of a target coating from a coating-measurement instrument. The plurality of coating spatial appearance variables comprises a graininess variable, a sparkle area variable, and a sparkle intensity variable. The computerized method also comprises generating target spatial appearance space coordinates for the target coating by mapping each of the plurality of coating spatial appearance variables to an individual axis in a multidimensional coordinate system. The graininess variable is mapped to a first axis of the multidimensional coordinate system. The sparkle area variable is mapped to a second axis of the multidimensional coordinate system. Additionally, the sparkle intensity variable is mapped to a third axis of the multidimensional coordinate system. The computerized method comprises accessing a database of spatial appearance space coordinates. The database comprises multiple unique spatial appearance space coordinates in the multidimensional coordinate system associated with different reference coatings. Additionally, the computerized method comprises identifying spatial appearance space coordinates associated with a plurality of potentially matching reference coatings from the database of spatial appearance space coordinates. The computerized method further comprises calculating a spatial-appearance-space distance between the identified spatial appearance space coordinates associated with the potentially matching reference coatings and the spatial appearance space coordinates of the target coating for each of said potentially matching reference coatings. Further still, the method comprises identifying particular spatial appearance space coordinates from the identified spatial appearance space coordinates associated with the plurality of potentially matching reference coatings that are associated with a smallest spatial-appearance-space distance from the spatial appearance space coordinates of the target coating. The method also comprises displaying a visual interface element indicating a particular reference coating that is associated with the particular spatial appearance space coordinates as a proposed spatial appearance match to the target coating.

The present invention also relates to computer systems and computerized methods for mapping coatings to a spatial appearance space, and related computer program products as specified in the appended independent claims. According to the present invention, a computer system for mapping coatings to a spatial appearance space is provided, which comprises one or more processors and one or more computer-readable media having stored thereon executable instructions that when executed by the one or more processors configure the computer system to perform various acts. The computer system is configured to receive a plurality of coating spatial appearance variables of a target coating from a coating-measurement instrument. The one or more coating spatial appearance variables comprise a graininess variable, a sparkle area variable, and a sparkle intensity variable. The computer system is also configured to generate spatial appearance space coordinates for the target coating by mapping each of the one or more coating spatial appearance variables to an individual axis of a multidimensional coordinate system. The graininess variable is mapped to a first axis of the multidimensional coordinate system, the sparkle area variable is mapped to a second axis of the multidimensional coordinate system, and the sparkle intensity variable is mapped to a third axis of the multidimensional coordinate system. The computer system accesses a database of spatial appearance space coordinates. The database comprises multiple unique spatial appearance space coordinates in said multidimensional coordinate system associated with different reference coatings. The computer system also identifies spatial appearance space coordinates associated with a plurality of potentially matching reference coatings from the database of spatial appearance space coordinates. In addition, the computer system calculates a spatial-appearance-space distance between the one identified spatial appearance space coordinates associated with the potentially matching reference coatings and the spatial appearance space coordinates of the target coating for each of said potentially matching reference coatings. Further, the computer system identifies particular spatial appearance space coordinates from the identified spatial appearance space coordinates associated with the potentially matching reference coatings that are associated with the smallest spatial-appearance-space distance from the spatial appearance space coordinates of the target coating. Further still, the computer system displays a visual interface element indicating a particular reference coating that is associated with the particular spatial appearance space coordinates as a proposed spatial appearance match to the target coating.

Additionally, the present invention also comprises a computer program product comprising one or more computer storage media having stored thereon computer-executable instructions that, when executed at a processor, cause the computer system to perform a method for mapping coatings to a spatial appearance space. The computer system receives a plurality of coating spatial appearance variables of a target coating from a coating-measurement instrument. The one or more coating spatial appearance variables comprise a graininess variable, a sparkle area variable, and a sparkle intensity variable. The computer system also generates spatial appearance space coordinates for the target coating by mapping each of the one or more coating spatial appearance variables to an individual axis of a multidimensional coordinate system. The graininess variable is mapped to a first axis of the multidimensional coordinate system, the sparkle area variable is mapped to a second axis of the multidimensional coordinate system, and the sparkle intensity variable is mapped to a third axis of the multidimensional coordinate system. The computer system accesses a database of spatial appearance space coordinates. The database comprises multiple unique spatial appearance space coordinates in said multidimensional coordinate system associated with different reference coatings. The computer system also identifies spatial appearance space coordinates associated with a plurality of potentially matching reference coatings from the database of spatial appearance space coordinates. In addition, the computer system calculates a spatial-appearance-space distance between the one identified spatial appearance space coordinates associated with the potentially matching reference coatings and the spatial appearance space coordinates of the target coating for each of said potentially matching reference coatings. Further, the computer system identifies particular spatial appearance space coordinates from the identified spatial appearance space coordinates associated with the potentially matching reference coatings that are associated with the smallest spatial-appearance-space distance from the spatial appearance space coordinates of the target coating. Further still, the computer system displays a visual interface element indicating a particular reference coating that is associated with the particular spatial appearance space coordinates as a proposed spatial appearance match to the target coating.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific examples thereof, which are illustrated in the appended drawings. Understanding that these drawings depict only examples of the invention and are not therefore to be considered to be limiting of its scope, the invention will be described and explained with additional specificity and detail through the use of the accompanying drawings introduced below.

FIG. 1 depicts a schematic diagram of an exemplary computer system according to the present invention for mapping target coatings to a spatial appearance space.

FIG. 2 depicts a three-dimensional coordinate system with exemplary spatial appearance space coordinates for a coating.

FIG. 3 depicts a three-dimensional coordinate system with an example of two different spatial appearance space coordinates for two different coatings.

FIG. 4 depicts a three-dimensional coordinate system with another example of two different spatial appearance space coordinates for two different coatings.

FIG. 5 depicts a flowchart of steps in an exemplary method for mapping target coatings to a spatial appearance space in accordance with the present invention.

FIG. 6 depicts a flowchart of steps in an exemplary method for identifying proposed coating matches.

FIG. 7 depicts a schematic of an exemplary method for identifying proposed coating matches.

FIG. 8 depicts a schematic of another exemplary method for identifying proposed coating matches.

### DETAILED DESCRIPTION

The present invention extends to systems, methods, and apparatus for mapping target coatings to a spatial appearance space. As used herein, a target coating comprises any coating of interest. Additionally, as used herein “spatial appearance” is defined to mean those attributes of appearance that have a spatial component including texture, graininess, sparkle, etc. One will appreciate that coating color does not contribute to spatial appearance. Further, “texture” is defined to mean the visible structure depending on the size and organization of small constituent parts of a material; typically, the subsurface structure of a gonioapparent material. Typical texture components within coatings comprise aluminum flakes, mica, or other effect components.

The spatial appearance space disclosed herein may provide several benefits to the field of coating identification and matching. For example, conventional identification of spatial appearance components within a coating involves a wide range of different methods and systems that are typically mutually exclusive to each other. For many users, this results in a “black box” system where the user enters data into a system and the system, without any transparency or understanding from the user, generates spatial appearance information, which may include proposed matching coatings.

This lack of uniformity creates confusion and challenges within the technical space because the outputs of many of these spatial appearance processing systems are not immediately useful outside the system. For instance, a first manufacturer may generate spatial appearance data using the manufacturer's proprietary methods and outputs. A second manufacturer may do the same, while using different methods and different outputs. This creates significant technical burdens when users wish to utilize spatial appearance data within their own systems for further processing. Due to the lack of uniformity, the user is often required to create custom solutions for each and every manufacturer. Further, these custom solutions must often be created without the benefit of understanding how the outputs are calculated.

In contrast to these conventional systems, the present invention provides a novel and inventive system to analyzing spatial appearances of coatings and mapping the spatial appearance of the coatings to a common spatial appearance space. Such a mapping allows for more efficient processing in that all spatial appearance components can be commonly mapped to the same space. Such a mapping also allows for the easy use of outputted data. In particular, since a common coordinate system can be used to describe different coatings, further processing can be performed on a coordinate basis for all of the different coatings.

Accordingly, a computer system of the disclosed invention is configured to process data from a target coating. The target coating is analyzed using one or more tools known in the art to derive spatial appearance data, such as texture data. The tools may comprise spectrophotometers, cameras, and/or other devices used to extract spatial appearance data from a coating. For example, tools such as BykGardner's BykMac and X-Rite's MA98 may be used to analyze the target coating. Using novel means disclosed herein, the spatial appearance data is processed in order to identify attributes relating to the spatial appearance data and/or to identify one or more reference coatings that also comprise the same or similar spatial appearance data. As disclosed more fully herein, the processing of the spatial appearance data may occur with significant improvements in efficiency and accuracy due to the methods and systems disclosed herein.

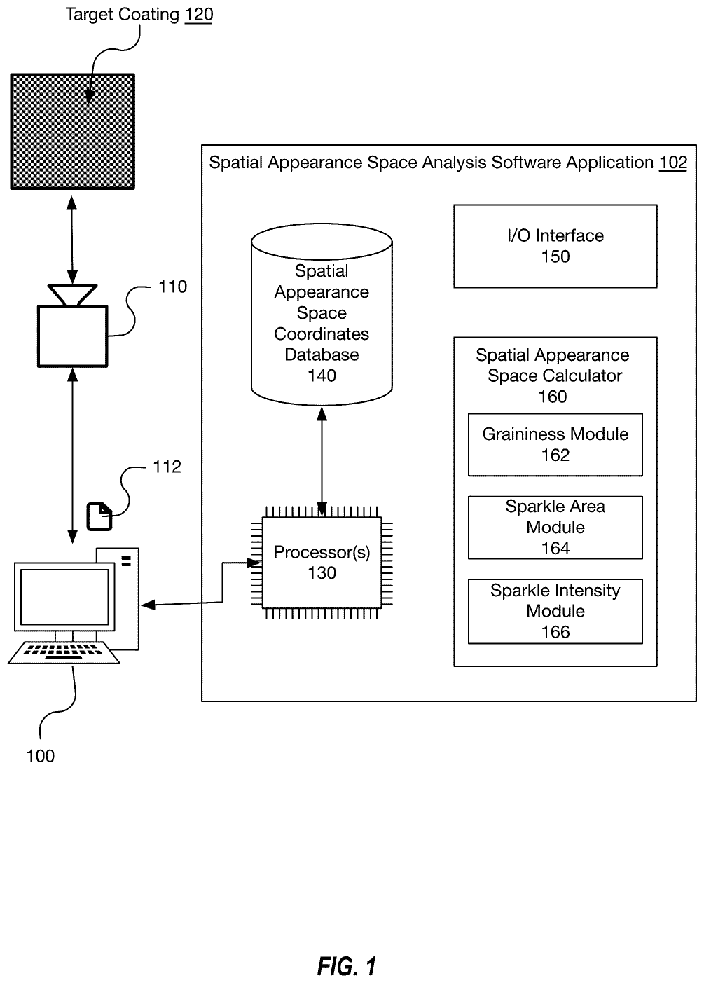

For example, FIG. 1 depicts a schematic diagram of an exemplary computer system 100 for mapping target coatings to a spatial appearance space. The computer system 100 comprises one or more processors 130 and one or more computer-readable media having stored thereon executable instructions for a spatial appearance space analysis software application 102 that when executed by the one or more processors 130 configure the computer system 100 to perform various acts. For instance, the computer system 100 may receive one or more coating spatial appearance variables 112 of a target coating 120 from a coating-measurement instrument 110, such as a spectrophotometer.

For example, the one or more coating spatial appearance variables 112 comprise a graininess variable, a sparkle area variable, and a sparkle intensity variable. As used herein, the graininess variable comprises an identified contrast of the light/dark irregular patterns exhibited by the target coating when viewed under illumination. The illumination may be directional or diffuse and may be determined by the device taking the measurements or by the spatial appearance space analysis software application 102. The graininess variable may be calculated by first identifying light/dark patterns in an image of the target coating using conventional image processing techniques. A contrast number may then be calculated based upon the contrast of the light/dark irregular patterns within respect to the rest of the coating.

The sparkle area variable comprises an area segment of spots that are more than a threshold level brighter than their immediate surroundings on an illuminated portion of the target coating. For instance, the spots may initially be identified using the threshold level of relative brightness. Once identified, the area of the identified spots can be calculated. In some cases, the area of the identified spots may be normalized with respect to the total analyzed area of the target coating 120.

The sparkle intensity variable comprises a contrast between appearance highlights on particles of a gonioapparent pigment and the particles' immediate surroundings. For instance, a threshold may be used to identify highlights on particles of a gonioapparent pigment. The threshold may be based upon a predetermined intensity rating and/or by a relative brightness of the highlights with respect to the coating. Once identified, a contrast between the highlights and the immediately surrounding particles can be calculated on a per pixel basis within an image of the target coating 120.

The graininess variable may comprise graininess measurements taken at multiple angles by the coating-measurement instrument 110. One of skill in the art will appreciate that many conventional spectrophotometers comprise detectors and/or illuminators positioned at multiple pre-determined angles. As such, spectrophotometric data received from a spectrophotometer may comprise measurements (including directional graininess measurements) taken at multiple angles. Similarly, the sparkle area variable may comprise sparkle area measurements taken at the multiple angles by the coating-measurement instrument 110. Likewise, the sparkle intensity variable may comprise sparkle intensity measurements taken at the multiple angles by the coating-measurement instrument.

Once the one or more coating spatial appearance variables 112 are gathered, a spatial appearance space calculator 160 generates target spatial appearance space coordinates for the target coating by mapping the coating spatial appearance variables to the different axes of a multidimensional coordinate system. Herein, each type of coating spatial appearance variable is generally mapped on an individual axis of the multidimensional coordinate system. In particular, a graininess module 162 maps the graininess variable to a first axis of the multidimensional coordinate system, a sparkle area module 164 maps the sparkle area variable to a second axis of the multidimensional coordinate system, and a sparkle intensity module 166 maps the sparkle intensity variable to a third axis of the multidimensional coordinate system.

The unique combination of graininess, sparkle area, and sparkle intensity provides a unique and accurate insight into the spatial appearance components of a coating. Additionally, the disclosed combination of graininess, sparkle area, and sparkle intensity provide a highly efficient condensing of data into mathematically efficient coordinates. These spatial appearance components can be mapped to a n-dimensional axis. This spatial mapping of the spatial appearance components provides for a computationally efficient means of comparing different spatial appearance characteristics in different coatings. For instance, different coatings with spatial appearance space coordinates that map closely to each other are more similar to each other than those with spatial appearance space coordinates that map further away from each other.

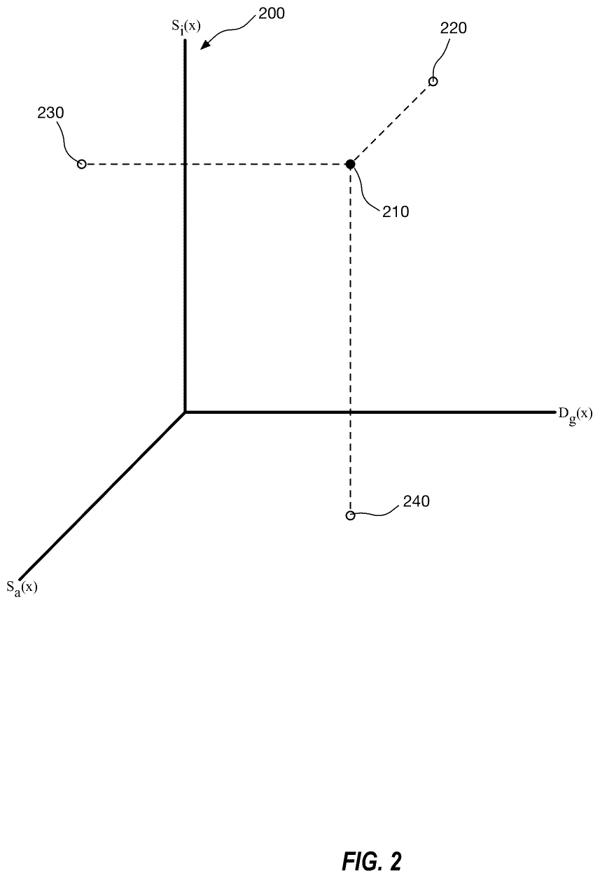

For example, FIG. 2 depicts a three-dimensional coordinate system 200 with an example of a spatial appearance space coordinates 210 for a coating. In the depicted three-dimensional coordinate system 200, Sa (x) represents the sparkle area axis, Si (x) represents the sparkle intensity axis, and Dg (x) represents the graininess axis. Planar point 220 depicts the two-dimensional intersection between the sparkle intensity variable and the graininess variable. Planar point 230 depicts the two-dimensional intersection between the sparkle intensity variable and the sparkle area variable. Planar point 240 depicts the two-dimensional intersection between the graininess variable and the sparkle area variable.

The spatial appearance space coordinates of the target coating 120 represents a mapping of the spatial appearance information from the target coating 120 to a three-dimensional space. One will appreciate that additional spatial appearance variables could be added to the mapping such that an n-dimensional mapping occurs. Such a mapping provides unique information relating to the attributes of the coating. The unique information is also readily processed using simple distance-based geometric equations, which provide significant computational benefits over conventional methods of spatial appearance analysis. As used herein, a texture space may be a subset of spatial appearance space. As such, a texture space may be generated using the methods and systems described herein.

For example, when analyzing the target coating 120, the coating-measurement instrument 110 may generate any number of different variables. In some instances, the different variables may need to undergo some initial processing by the one or more processors 130 in order to calculate the graininess, sparkle area, or sparkle intensity. Further, in some instances, the different spatial appearance variables may be normalized on a per-instrument basis. One will appreciate that many different coating-measurement instruments 110 output data that is not to a single common scale. As such, this data can be normalized such that each data outputted by each instrument is normalized based upon a maximum possible output value for each spatial appearance variable. As such, the resulting spatial appearance data would be between zero and one. This normalized data can then be used to generate spatial appearance coordinates. Such a system of normalizing the output provides the technical benefit of allowing multiple different devices to communicate within a common spatial appearance space.

In addition to generating spatial appearance space coordinates for the target coating 120, the one or more processors 130 may access a database of spatial appearance space coordinates 140 that comprises multiple unique spatial appearance space coordinates associated with different reference coatings. The multiple unique spatial appearance space coordinates may be based upon different known coatings. For instance, an entire library, product line, or brand catalogue of coatings may be analyzed and added to the database of spatial appearance space coordinates 140.

The one or more processors may identify spatial appearance space coordinates associated with a plurality of potentially matching reference coatings from the database of spatial appearance space coordinates. The identified spatial appearance space coordinates may comprise any subset of the spatial appearance space coordinates within the database. For example, the identified spatial appearance space coordinates may comprise every set of spatial appearance space coordinates within the database. Additionally or alternatively, the one or more processors may filter the spatial appearance space coordinates within the database, such that the identified spatial appearance space coordinates are associated with potentially matching reference coatings that comprise the same color, same effect texture types, or some other similar attributes to the target coating. Additionally or alternatively, the one or more processors may identify the spatial appearance space coordinates associated with the plurality of potentially matching reference coatings by selecting the spatial appearance space coordinates, from the database of spatial appearance space coordinates, that appear within the same orthant as the target coating's spatial appearance space coordinates. The identified spatial appearance space coordinates may also, for example, be selected based upon being within a threshold distance to the target coating's spatial appearance space coordinates.

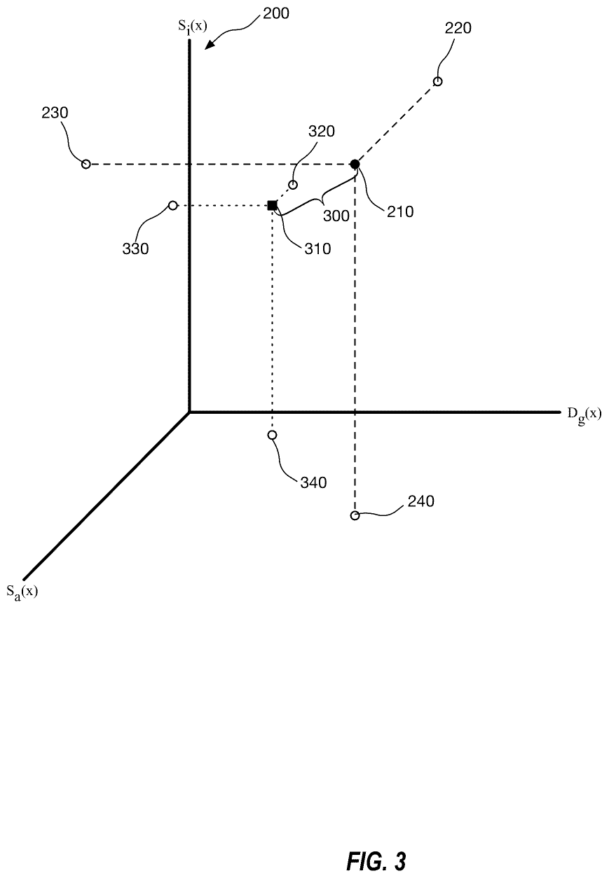

After identifying the spatial appearance space coordinates associated with one or more reference coatings from the database, the one or more processors 130 may calculate a spatial-appearance-space distance between each of the identified spatial appearance space coordinates and the target spatial appearance space coordinates 210. For example, FIG. 3 depicts a three-dimensional coordinate system with an example of two different spatial appearance space coordinates 210, 310 for two different coatings. The spatial appearance space coordinate 210 for the target coating is depicted with another spatial appearance space coordinate 310 for a reference coating. Planar point 320 depicts the two-dimensional intersection between the sparkle intensity variable and the graininess variable. Planar point 330 depicts the two-dimensional intersection between the sparkle intensity variable and the sparkle area variable. Planar point 340 depicts the two-dimensional intersection between the graininess variable and the sparkle area variable.

The spatial-appearance-space distance 300 can be calculated using any number of different distance equations. For example, the below equation may be used to calculate spatial-appearance-space distance 300.

$$d = \sqrt{{( {x}_{2} - {x}_{1} )}^{2} + {( {y}_{2} - {y}_{1} )}^{2} + {( {z}_{2} - {z}_{1} )}^{2}}$$

The distance equation may be normalized to the values of each component within the target coating spatial appearance coordinate 210. Additionally, the distance between each planar point pair (220 and 320, 230 and 330, 240 and 340) may also be calculated.

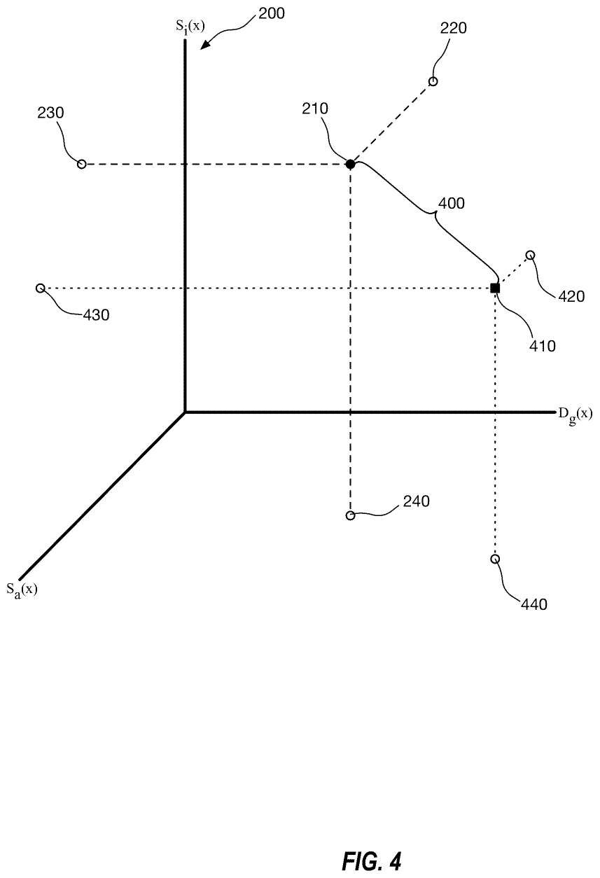

FIG. 4 also depicts a three-dimensional coordinate system with another example of two different spatial appearance space coordinates 210, 410 for two different coatings. The spatial appearance space coordinate 210 for the target coating is depicted with yet another spatial appearance space coordinate 410 for another reference coating. Planar point 420 depicts the two-dimensional intersection between the sparkle intensity variable and the graininess variable. Planar point 430 depicts the two-dimensional intersection between the sparkle intensity variable and the sparkle area variable. Planar point 440 depicts the two-dimensional intersection between the graininess variable and the sparkle area variable. The one or more processors 130 calculate spatial-appearance-space distance 400.

As discussed above, the coating-measurement instrument 110 may gather the coating spatial appearance variables from multiple different angles. The spatial appearance space calculator 160 can then map, on a per angle basis from the multiple angles, each graininess measurement from the graininess variable, each sparkle area measurement from the sparkle area variable, and each sparkle intensity measurement from the sparkle intensity variable to the multidimensional coordinate system. As such, the one or more target spatial appearance space coordinates for a target coating 120 may comprise multiple per angle coordinates.

The one or more processors 130 can calculate one or more distances between the spatial appearance space coordinates for a specific coating selected from the one or more reference coatings and the target spatial appearance space coordinates for the target coating 120 on a per angle basis. Each of the spatial appearance space coordinates for the specific coating and each of the target spatial appearance space coordinates for the target coating can be associated with a predetermined set of angles, such that the one or more distances comprise calculated distances between the target spatial appearance space coordinates for the target coating and the spatial appearance space coordinates for the specific coating on a per angle basis for each angle within the predetermined set of angles. The one or more processors 130 can then generate the spatial-appearance-space distance between the target coating 120 and the specific coating by calculating a sum of squares of the plurality of determined distances.

The one or more processors 130 then identifies particular spatial appearance space coordinates from the identified spatial appearance space coordinates 310, 410 associated with the reference coatings that are associated with the smallest spatial-appearance-space distance 300, 400 from the target spatial appearance space coordinates 210. For instance, spatial-appearance-space distance 300 in FIG. 3 is smaller than spatial-appearance-space distance 400 in FIG. 4. As such, the one or more processors 130 identify spatial appearance space coordinate 300 as being the spatial appearance space coordinates that are associated with a proposed reference coating for matching the target coating 120.

The computer system 100 may also receive one or more coating color variables of the target coating 120 from the coating-measurement instrument 110. The coating color variables may comprise spectral data, LAB data, or any other data indicating the color of the target coating 120. The one or more processors 130 may identify a color associated with the target coating 120. The one or more processors 130 may also receive a coating color variable in the form of a color code that is associated with the target coating 120. For instance, the target coating 120 may be on a car panel. The car may be associated with a color code that indicates the color of the paint. The one or more processors 130 may then identify spatial appearance space coordinates from a subset of one or more coatings that are associated with the color code. As such, the one or more processors 130 can identify the one or more proposed coatings based upon the spatial-appearance-space distance between each of the identified spatial appearance space coordinates associated with the potentially matching reference coatings in the database and the target spatial appearance space coordinates and at least one other coating attribute, such as color, associated with the target coating 120.

The I/O interface 150 then displays a visual interface element indicating a particular reference coating that is associated with the particular spatial appearance space coordinates as a proposed spatial appearance match to the target coating. As indicated above the particular spatial appearance space coordinates are associated with the smallest spatial-appearance-space distance from the spatial appearance space coordinates of the target coating. The visual interface element may comprise a visual representation of the spatial appearance space coordinates for the target coating 120. The one or more processors 130 may also create a formulation for the particular reference coating (also referred to herein as the “proposed coating”) based upon the formulation stored within the database of spatial appearance space coordinates. The formulation may be communicated to a coating production machine for the physical creation and mixing for the coating.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

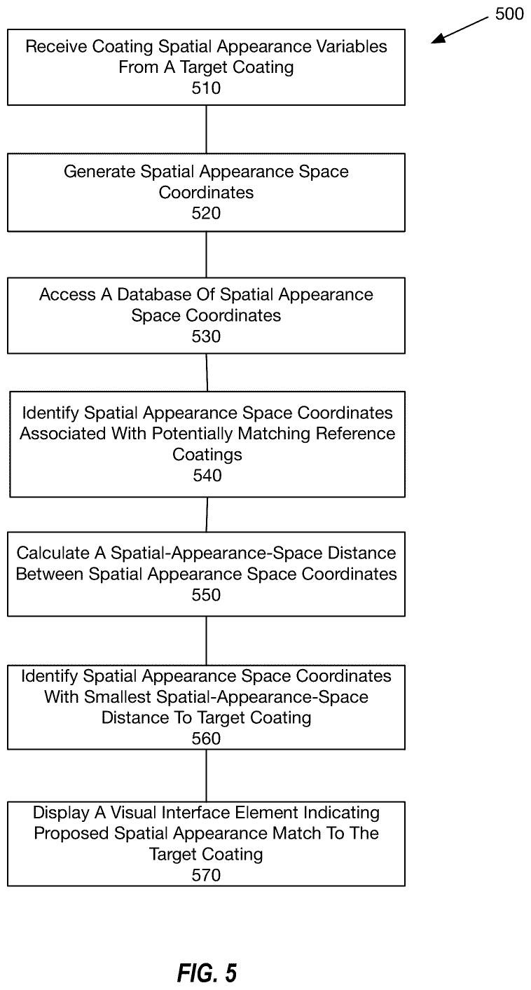

FIG. 5 depicts a flowchart of steps in an exemplary method 500 for mapping coatings to a spatial appearance space. The method 500 comprises an act 510 of receiving coating spatial appearance variables from a target coating. Act 510 includes receiving coating spatial appearance variables of a target coating 120 from a coating-measurement instrument 110, wherein the coating spatial appearance variables comprise a graininess variable, a sparkle area variable, and a sparkle intensity variable. For instance, as depicted and described with respect to FIG. 1, the coating-measurement instrument 110 receives coating spatial appearance variables from the target coating 120. The spatial appearance variables are sent to the computer system 100 for further processing.

Additionally, method 500 comprises an act 520 of generating spatial appearance space coordinates. Act 520 includes generating target spatial appearance space coordinates for the target coating by mapping the coating spatial appearance variables to the different axes of a multidimensional coordinate system. Specifically, the graininess variable is mapped to a first axis of the multidimensional coordinate system, the sparkle area variable is mapped to a second axis of the multidimensional coordinate system, and the sparkle intensity variable is mapped to a third axis of the multidimensional coordinate system. For example, as depicted and described with respect to FIGS. 1 and 2 the spatial appearance space calculator 160 calculates coordinates within a spatial appearance space for the target coating 120 spatial appearance variables. The spatial appearance space calculator 160 may comprise a software module within the spatial appearance space analysis software application 102. The spatial appearance space calculator comprises a graininess module 162, a sparkle area module, and a sparkle intensity module 166.

Method 500 also comprises an act 530 of accessing a database of spatial appearance space coordinates. Act 530 includes accessing a database of spatial appearance space coordinates. The database comprises multiple unique spatial appearance space coordinates associated with different reference coatings. For example, as depicted and described with respect to FIGS. 1, the computer system 100 comprises a spatial appearance space coordinates database 140. The one or more processors 130 access the spatial appearance space coordinates database 140 and identify spatial appearance space coordinates associated with potentially matching reference coatings.

The method 500 thus also comprises an act 540 of identifying spatial appearance space coordinates associated with potentially matching reference coatings. Act 540 identifies spatial appearance space coordinates associated with a plurality of potentially matching reference coatings from the database of spatial appearance space coordinates. For example, as depicted and described with respect to FIGS. 1, 3, and 4, the computer system 100 identifies, from within the database 140, spatial appearance space coordinates associated with a plurality of potentially matching reference coatings that are relatively close to the target spatial appearance space coordinates. FIG. 3 depicts a predetermined spatial appearance space coordinates 310 and the target spatial appearance space coordinates 210. Similarly, FIG. 4 depicts a predetermined spatial appearance space coordinates 410 and the target spatial appearance space coordinates 210.

Method 500 also comprises an act 550 of calculating a spatial-appearance-space distance between spatial appearance space coordinates. Act 550 includes calculating a spatial-appearance-space distance between the predetermined spatial appearance space coordinates and the target spatial appearance space coordinates for each of the potentially matching reference coatings associated with the identified spatial appearance space coordinates. For instance, as depicted and described with respect to FIGS. 3 and 4, the computer system 100 calculates spatial-appearance-space distance 300 between target spatial appearance space coordinates 210 and predetermined spatial appearance space coordinates 310 and the spatial-appearance-space distance 400 between target spatial appearance space coordinates 210 and predetermined spatial appearance space coordinates 410.

Further, method 500 comprises an act 560 of identifying spatial appearance space coordinates with smallest spatial-appearance-space distance to target coating. Act 560 includes identifying particular spatial appearance space coordinates from the identified spatial appearance space coordinates associated with the plurality of potentially matching reference coatings that are associated with a smallest spatial-appearance-space distance from the spatial appearance space coordinates of the target coating. For instance, as depicted and described with respect to FIGS. 3 and 4, the computer system 100 determines that spatial-appearance-space distance 300 is smaller than spatial-appearance-space distance 400. Based upon this information, the computer system 100 determines that the coating associated with predetermined spatial appearance space coordinates 310 is the proposed spatial appearance space coordinates.

Further still, method 500 comprises an act 570 of displaying a visual interface element indicating proposed spatial appearance match to the target coating. Act 570 includes displaying a visual interface element indicating the reference coating that is associated with the particular spatial appearance space coordinates as a proposed spatial appearance match to the target coating. For example, the computer system 100 may display the three-dimensional coordinate system 200 of FIG. 3 with the target spatial appearance space coordinates 210, with its associated planar points 220, 230, 240, and the proposed spatial appearance space coordinates 310, with its associated planar points 320, 330, 340. Using both the coordinates 210, 310 and the planar points 220, 230, 240, 320, 330, 340, a user can quickly and easily identify the proximity of the match as well as individual differences within the planar points.

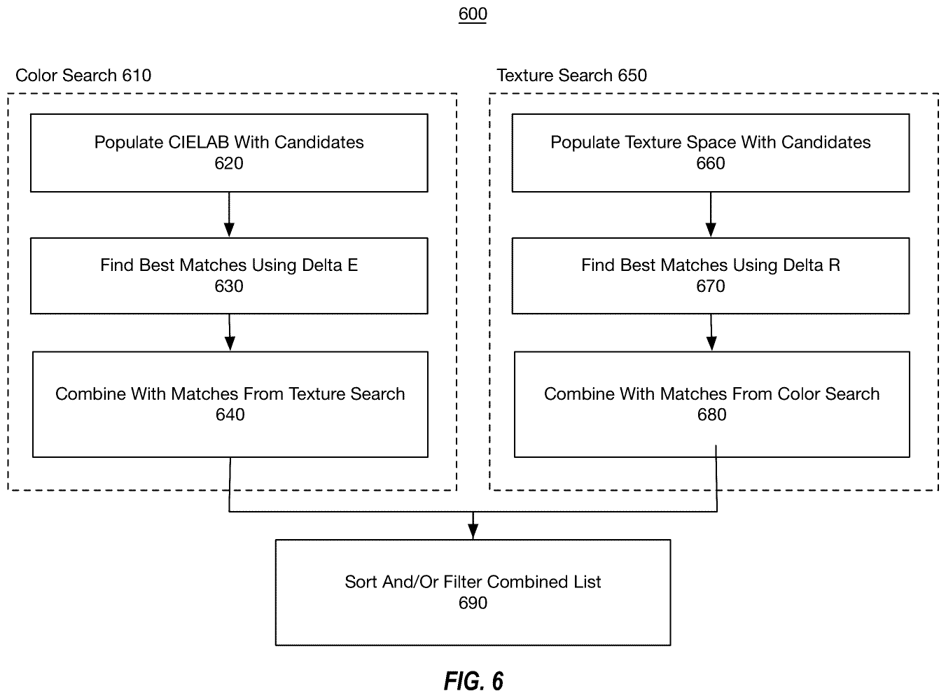

FIG. 6 depicts a flowchart of steps in an exemplary method for identifying proposed coating matches. In the depicted flowchart 600, the system performs a color search 610 in parallel with a texture search 650. By performing the searches in parallel, the system is able to provide computational efficiencies within multi-threaded processing systems.

Within the color search 610, the system receives one or more coating color variables of the target coating from the coating-measurement instrument 110 (shown in FIG. 1). The system then maps the one or more coating color variables to target color space coordinates within a color space. While any number of different known color spaces may be used, in at least one embodiment, the color space comprises the CIELAB color space.

The system identifies color space coordinates associated with a plurality of potentially matching color coatings from a database of reference coatings and associated color space coordinates. The system populates the CIELAB color space with the plurality of potentially matching color coatings (also referred to as candidate colors), shown as step 620. The system then calculates a color-space distance, also referred to as Delta E, between the identified color space coordinates associated with the potentially matching color coatings and the target color space coordinates of the target coating for each of the potentially matching color coatings.

As indicated by step 630, the system is then able to identify particular color space coordinates from the identified color space coordinates associated with the plurality of potentially matching color coatings that are associated with a smallest color-space distance from the color space coordinates of the target coating. For example, the system may select a set of particular color space coordinates that are associated with the closest distance match to the color space coordinates of the target coating. Additionally or alternatively, the system may select an entire set of potentially matching color coatings. The set of potentially matching color coatings may comprise coatings that are associated with coordinates that are within a threshold distance (Delta E) from the color space coordinates of the target coating. Alternatively, the set of potentially matching color coatings may comprise a threshold number of coatings that are associated with coordinates that are closest to the color space coordinates of the target coating. One will appreciate that because different color spaces may comprise different scales, the actual threshold values for distance between the color space coordinates of the target coating and coordinates of the potentially matching color coatings is somewhat arbitrary. In the described case, a user is able to select a threshold number of potentially matching coatings and/or a threshold Delta E distance based upon the user's particular use case and needs.

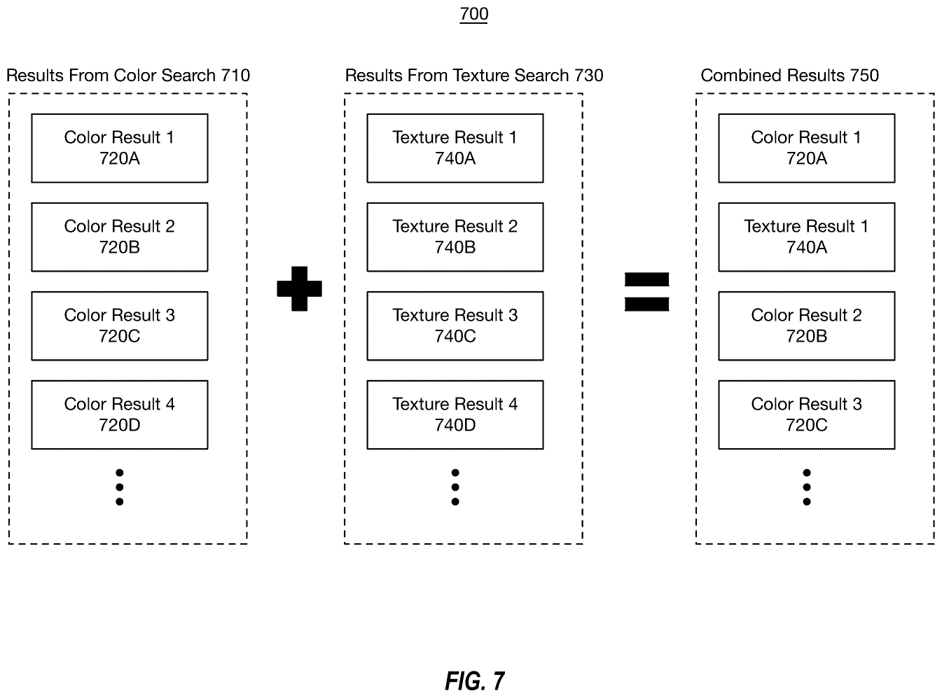

Within texture search 650, the system populates the texture space with candidates in step 660. As described above, the texture space comprises a subset of spatial appearance space and is generated using the methods and systems described herein. In step 670, the system finds the best texture space matches by identifying proposed texture matches within the smallest spatial-appearance-space distance from the coordinates of the target coating within the spatial distance space. As used herein, the spatial-appearance-space distance is referred to as “Delta R.” Steps 640 of combining matches from the texture search, step 680 of combining matches from the color search, and step 690 of sort and/or filter combined list are described below with respect to FIG. 7.

FIG. 7 depicts a schematic 700 of an exemplary method for identifying proposed coating matches. In FIG. 7, the results of the color search 710 are indicated as being a set of potential color matches 720(a-d). Similarly, the results of the texture search 730 are indicated as being a set of potential texture matches 740(a-d). Steps 640 and 680 from FIG. 6 are indicated by the combined results 750. In the depicted example, combined results 750 is generated by ordering the color results 720(a-d) and texture results 740(a-d) in order of increasing Delta E and Delta R. For instance, Color Result 1 (720A) comprises the smallest distance from the coordinates of the target color within each of the color space and the spatial appearance space. Texture Result 1 (740A) comprises the next smallest distance from the coordinates of the target color within each of the color space and the spatial appearance space. The combined results 750 continues in this pattern through Color Result 2 (720B), Color Result 3 (720C), and on through the desired numbers of proposed matching coatings.

Accordingly, as indicated in schematic 700, the system displays a visual interface element indicating a particular reference coating that is associated with the particular spatial appearance space coordinates and a particular color coating that is associated with the particular color space coordinates as proposed color matches to the target coating. While the recited scheme only indicates a single particular reference coating and a single particular color coating, one will appreciate that multiple reference coatings and color coatings can be displayed as indicated in the schematic 700. Additionally, as described above the system can order the particular reference coating and the particular color coating in order of increasing distance from the coordinates of the target coating within the respective color space and spatial appearance space.

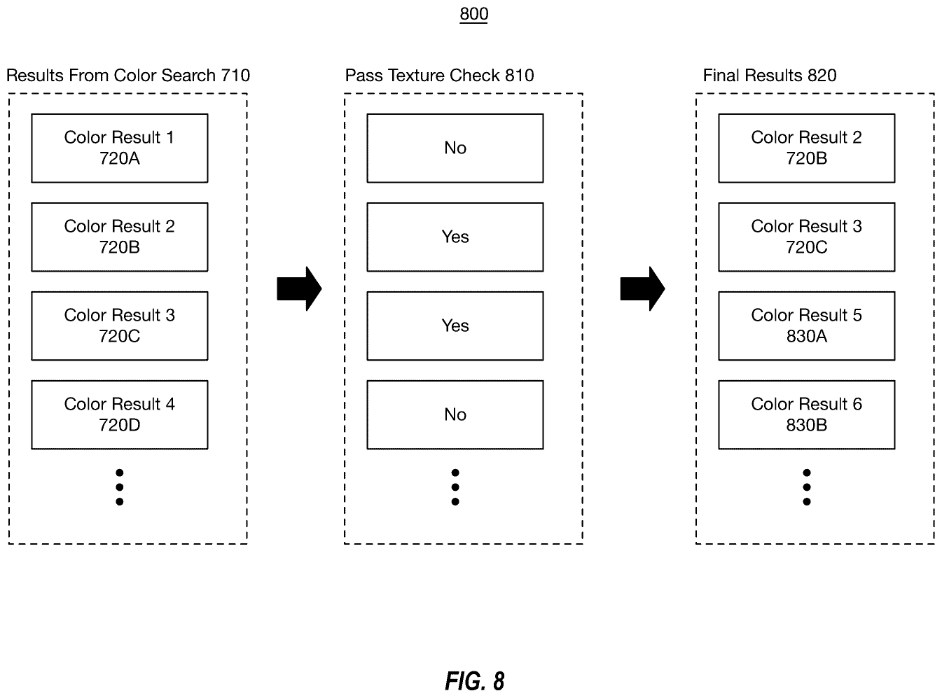

FIG. 8 depicts a schematic 800 of another exemplary method for identifying proposed coating matches. As depicted, the system generates results for the color search 710 as also indicated in FIG. 7. In particular, the system utilizes the steps described above with respect to FIG. 6 for receiving one or more coating color variables of the target coating from the coating-measurement instrument, mapping the one or more coating color variables to target color space coordinates within a color space, identifying color space coordinates associated with a plurality of potentially matching color coatings from a database of reference coatings and associated color space coordinates, and calculating a color-space distance between the identified color space coordinates associated with the potentially matching color coatings and the target color space coordinates of the target coating for each of said potentially matching color coatings.

Upon performing these steps, the system identifies a set of particular color space coordinates from the identified color space coordinates associated with the plurality of potentially matching color coatings that are within a threshold color-space distance from the color space coordinates of the target coating. As described above, the threshold can be set by the user based upon the desired number and quality of the proposed matching coatings.

The system then displays the visual interface element indicating a subset of particular color coatings that are associated with the set of particular color space coordinates as proposed color matches to the target coating. Specifically, the system performs a pass texture check 810 on each color result 720(A-D) within the results from the color search 710. The pass texture check 810 comprises identifying color results 720(A-D) that are associated with spatial-appearance-space distances that are within a threshold spatial-appearance-space distance to the target coating. As such, each identified color result 720(A-D) must be within a threshold of texture space difference from the target coating in order to be listed in the Final Results 820. As indicated above, this threshold may also be user set based upon user-defined constraints and needs. The resulting final results 820 then comprise the nearest color matches that are all within a threshold texture match from the target coating.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. The present invention may also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“laaS”). The cloud-computing model may also be deployed using different deployment models such as private cloud, community cloud, public cloud, hybrid cloud, and so forth.

Some configurations, such as a cloud-computing environment, may comprise a system that includes one or more hosts that are each capable of running one or more virtual machines. During operation, virtual machines emulate an operational computing system, supporting an operating system and perhaps one or more other applications as well. In some configurations, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention thus concerns inter alia, without being limited thereto, the following aspects:
1. A computerized method for mapping coatings to a spatial appearance space for use on a computer system comprising one or more processors and one or more computer-readable media having stored thereon executable instructions that when executed by the one or more processors configure the computer system to perform the method for mapping coatings to a spatial appearance space, the method comprising:
   receiving a plurality of coating spatial appearance variables of a target coating from a coating-measurement instrument, wherein the plurality of coating spatial appearance variables comprises a graininess variable, a sparkle area variable, and a sparkle intensity variable;
   generating target spatial appearance space coordinates for the target coating by mapping each of the plurality of coating spatial appearance variables to an individual axis in a multidimensional coordinate system, wherein:
      the graininess variable is mapped to a first axis of the multidimensional coordinate system,
      the sparkle area variable is mapped to a second axis of the multidimensional coordinate system, and
      the sparkle intensity variable is mapped to a third axis of the multidimensional coordinate system;
   accessing a database of spatial appearance space coordinates, wherein the database comprises multiple unique spatial appearance space coordinates in said multidimensional coordinate system associated with different reference coatings;
   identifying spatial appearance space coordinates associated with a plurality of potentially matching reference coatings from the database of spatial appearance space coordinates;
   calculating a spatial-appearance-space distance between the identified spatial appearance space coordinates associated with the potentially matching reference coatings and the spatial appearance space coordinates of the target coating for each of said potentially matching reference coatings;
   identifying particular spatial appearance space coordinates from the identified spatial appearance space coordinates associated with the plurality of potentially matching reference coatings that are associated with a smallest spatial-appearance-space distance from the spatial appearance space coordinates of the target coating; and
   displaying a visual interface element indicating a particular reference coating that is associated with the particular spatial appearance space coordinates as a proposed spatial appearance match to the target coating.
2. The computerized method according to preceding aspect 1, wherein:
   the graininess variable comprises graininess measurements taken at multiple angles by the coating-measurement instrument;
   the sparkle area variable comprises sparkle area measurements taken at the multiple angles by the coating-measurement instrument; and
   the sparkle intensity variable comprises sparkle intensity measurements taken at the multiple angles by the coating-measurement instrument.
3. The computerized method according to preceding aspect 2, wherein generating the spatial appearance space coordinates for the target coating by mapping the plurality of coating spatial appearance variables each to an individual axis of a multidimensional coordinate system further comprises:
   mapping, on a per angle basis from the multiple angles, each graininess measurement from the graininess variable, each sparkle area measurements from the sparkle area variable, and each sparkle intensity measurement from the sparkle intensity variable to the corresponding axis of the multidimensional coordinate system, such that the target spatial appearance space coordinates comprise multiple angular dependent coordinates.
4. The computerized method according to preceding aspect 3, wherein

calculating the spatial-appearance-space distance between each of the identified spatial appearance space coordinates associated with the potentially matching reference coatings and the spatial appearance space coordinates of the target coating further comprises:
calculating a plurality of distances between the spatial appearance space coordinates for a specific coating selected from the plurality of potentially matching reference coatings and the spatial appearance space coordinates for the target coating on a per angle basis, wherein each of the spatial appearance space coordinates for the specific coating and each of the spatial appearance space coordinates for the target coating are associated with a predetermined set of angles, such that the plurality of distances comprise calculated distances between the spatial appearance space coordinates for the target coating and the identified spatial appearance space coordinates for the specific coating on a per angle basis for each angle within the predetermined set of angles; and
   generating the spatial-appearance-space distance between the target coating and the specific coating by calculating a sum of squares of the plurality of distances.
5. The computerized method according to any one of preceding aspects 1 to 4, wherein the graininess variable comprises an identified contrast of light/dark irregular patterns exhibited by the target coating when viewed under illumination.
6. The computerized method according to any one of preceding aspects 1 to 5, wherein the sparkle area variable comprises an area segment of spots that are more than a threshold level brighter than their immediate surround on an illuminated portion of the target coating.
7. The computerized method according to any one of preceding aspects 1 to 6, wherein the sparkle intensity variable comprises a contrast between appearance highlights on particles of a gonioapparent pigment and the particles' immediate surroundings.
8. The computerized method according to any one of preceding aspects 1 to 7, wherein the displaying step comprises displaying a visual representation of the spatial appearance space coordinates for the target coating.
9. The computerized method according to any one of preceding aspects 1 to 8, wherein identifying the particular reference coating for matching the target coating comprises identifying the particular reference coating based upon the calculated spatial-appearance-space distance and at least one other coating attribute associated with the target coating.
10. The computerized method according to any one of preceding aspects 1 to 9, further comprising:
   receiving one or more coating color variables of the target coating from the coating-measurement instrument;
   mapping the one or more coating color variables to target color space coordinates within a color space;
   identifying color space coordinates associated with a plurality of potentially matching color coatings from a database of reference coatings and associated color space coordinates;
   calculating a color-space distance between the identified color space coordinates associated with the potentially matching color coatings and the target color space coordinates of the target coating for each of said potentially matching color coatings; and
   identifying particular color space coordinates from the identified color space coordinates associated with the plurality of potentially matching color coatings that are associated with a smallest color-space distance from the color space coordinates of the target coating.
11. The computerized method according to preceding aspect 10, further comprising:
   displaying the visual interface element indicating the particular reference coating that is associated with the particular spatial appearance space coordinates and a particular color coating that is associated with the particular color space coordinates as proposed color matches to the target coating; and
   ordering the particular reference coating and the particular color coating in order of increasing distance from the coordinates of the target coating within the respective color space and spatial appearance space.
12. The computerized method according to any one of preceding aspects 1 to 9, wherein identifying the spatial appearance space coordinates associated with the plurality of potentially matching coatings from the database of spatial appearance space coordinates comprises:
   receiving one or more coating color variables of the target coating from the coating-measurement instrument;
   mapping the one or more coating color variables to target color space coordinates within a color space;
   identifying color space coordinates associated with a plurality of potentially matching color coatings from a database of reference coatings and associated color space coordinates;
   calculating a color-space distance between the identified color space coordinates associated with the potentially matching color coatings and the target color space coordinates of the target coating for each of said potentially matching color coatings;
   identifying a set of particular color space coordinates from the identified color space coordinates associated with the plurality of potentially matching color coatings that are within a threshold color-space distance from the color space coordinates of the target coating; and
   displaying the visual interface element indicating a subset of particular color coatings that are associated with the set of particular color space coordinates as proposed color matches to the target coating, wherein the subset of particular color coatings comprise color coatings that are associated with spatial-appearance-space distances that are within a threshold spatial-appearance-space distance to the target coating.
13. A computer system for mapping coatings to a spatial appearance space, e.g. for use with the computerized method according to any one of preceding aspects 1 to 12, the computer system comprising:
   one or more processors; and
   one or more computer-readable media having stored thereon executable instructions that when executed by the one or more processors configure the computer system to perform at least the following:
      receive a plurality of coating spatial appearance variables of a target coating from a coating-measurement instrument, wherein the plurality of coating spatial appearance variables comprises a graininess variable, a sparkle area variable, and a sparkle intensity variable;
      generate target spatial appearance space coordinates for the target coating by mapping each of the plurality of spatial appearance variables to an individual axis in a multidimensional coordinate system, wherein:
         the graininess variable is mapped to a first axis of the multidimensional coordinate system,
         the sparkle area variable is mapped to a second axis of the multidimensional coordinate system, and
         the sparkle intensity variable is mapped to a third axis of the multidimensional coordinate system;
      access a database of spatial appearance space coordinates, wherein the database comprises multiple unique spatial appearance space coordinates in said multidimensional coordinate system associated with different reference coatings;
      identify spatial appearance space coordinates associated with a plurality of potentially matching reference coatings from the database of spatial appearance space coordinates;
      calculate a spatial-appearance-space distance between the identified spatial appearance space coordinates associated with the potentially matching reference coatings and the spatial appearance space coordinates of the target coating for each of said potentially matching reference coatings;
      identify particular spatial appearance space coordinates from the identified spatial appearance space coordinates associated with the plurality of potentially matching reference coatings that are associated with a smallest spatial-appearance-space distance from the spatial appearance space coordinates of the target coating; and
      display a visual interface element indicating a particular reference coating that is associated with the particular spatial appearance space coordinates as a proposed spatial appearance match to the target coating.
14. The computer system according to preceding aspect 13, wherein:
   the graininess variable comprises graininess measurements taken at multiple angles by the coating-measurement instrument;
   the sparkle area variable comprises sparkle area measurements taken at the multiple angles by the coating-measurement instrument; and
   the sparkle intensity variable comprises sparkle intensity measurements taken at the multiple angles by the coating-measurement instrument.
15. The computer system according to aspect 14, wherein generating the spatial appearance space coordinates for the target coating by mapping the plurality of coating spatial appearance variables each to an individual axis of a multidimensional coordinate system further comprises:
   mapping, on a per angle basis from the multiple angles, each graininess measurement from the graininess variable, each sparkle area measurements from the sparkle area variable, and each sparkle intensity measurement from the sparkle intensity variable to the corresponding axis of the multidimensional coordinate system, such that the target spatial appearance space coordinates comprise multiple angular dependent coordinates.
16. The computer system according to aspect 15, wherein calculating the spatial-appearance-space distance between each of the identified spatial appearance space coordinates associated with the potentially matching reference coatings and the spatial appearance space coordinates of the target coating further comprises:
   calculating a plurality of distances between the spatial appearance space coordinates for a specific coating selected from the plurality of potentially matching reference coatings and the spatial appearance space coordinates for the target coating on a per angle basis, wherein each of the spatial appearance space coordinates for the specific coating and each of the spatial appearance space coordinates for the target coating are associated with a predetermined set of angles, such that the plurality of distances comprise calculated distances between the spatial appearance space coordinates for the target coating and the identified spatial appearance space coordinates for the specific coating on a per angle basis for each angle within the predetermined set of angles; and
   generating the spatial-appearance-space distance between the target coating and the specific coating by calculating a sum of squares of the plurality of distances.
17. The computer system according to any one of preceding aspects 13 to 16, wherein the graininess variable comprises an identified contrast of light/dark irregular patterns exhibited by the target coating when viewed under illumination.
18. The computer system according to any one of preceding aspects 13 to 17, wherein the sparkle area variable comprises an area segment of spots that are more than a threshold level brighter than their immediate surround on an illuminated portion of the target coating.
19. The computer system according to any one of preceding aspects 13 to 18, wherein the sparkle intensity variable comprises a contrast between appearance highlights on particles of a gonioapparent pigment and the particles' immediate surroundings.
20. The computer system according to any one of preceding aspects 13 to 19, wherein the visual interface element comprises a visual representation of the spatial appearance space coordinates for the target coating.
21. The computer system according to any one of preceding aspects 13 to 20, wherein the executable instructions include instructions that are executable to further configure the computer system to:
   receive one or more coating color variables of the target coating from the coating-measurement instrument; and
   identify a color associated with the target coating.
22. The computer system according to any one of preceding aspects 13 to 21, wherein the executable instructions include instructions that are executable to further configure the computer system to create a formulation for the particular reference coating.
23. The computer system according to any one of preceding aspects 13 to 22, wherein identifying the spatial appearance space coordinates associated with the plurality of potentially matching reference coatings from the database of spatial appearance space coordinates comprises:
   receiving a color code that is associated with the target coating, and identifying spatial appearance space coordinates for coatings that are associated with the color code.
24. A computer program product comprising one or more computer storage media having stored thereon computer-executable instructions that, when executed at a processor, cause a computer system, such as a computer system according to any one of preceding aspects 13 to 23, to perform a method for mapping coatings to a spatial appearance space, the method comprising:
   receiving a plurality of coating spatial appearance variables of a target coating from a coating-measurement instrument, wherein the plurality of coating spatial appearance variables comprises a graininess variable, a sparkle area variable, and a sparkle intensity variable;
   generating target spatial appearance space coordinates for the target coating by mapping each of the one or more coating spatial appearance variables to an individual axis in a multidimensional coordinate system, wherein:
      the graininess variable is mapped to a first axis of the multidimensional coordinate system,
      the sparkle area variable is mapped to a second axis of the multidimensional coordinate system, and
      the sparkle intensity variable is mapped to a third axis of the multidimensional coordinate system;
   accessing a database of spatial appearance space coordinates, wherein the database comprises multiple unique spatial appearance space coordinates in said multidimensional coordinate system associated with different reference coatings;
   identifying spatial appearance space coordinates associated with a plurality of potentially matching reference coatings from the database of spatial appearance space coordinates;
   calculating a spatial-appearance-space distance between the identified spatial appearance space coordinates associated with the potentially matching reference coatings and the spatial appearance space coordinates of the target coating for each of said potentially matching reference coatings;
   identifying particular spatial appearance space coordinates from the identified spatial appearance space coordinates associated with the plurality of potentially matching reference coatings that are associated with a smallest spatial-appearance-space distance from the spatial appearance space coordinates of the target coating; and
   displaying a visual interface element indicating a particular reference coating that is associated with the particular spatial appearance space coordinates as a proposed spatial appearance match to the target coating.
25. The computer program product according to preceding aspect 24, comprising further computer-executable instructions that, when executed at a processor, cause the computer system, to perform the method for mapping coatings to a spatial appearance space with the additional features as defined above in any one of preceding aspects 2 to 12.

The present invention may be embodied in other specific forms without departing from its spirit or essential characteristics. The described inventions are to be considered in all respects only as illustrative and not restrictive. The scope of the invention is, therefore, indicated by the appended claims rather than by the foregoing description. All changes which come within the meaning and range of equivalency of the claims are to be embraced within their scope.

The invention claimed is:

1. A computer system for mapping coatings to a spatial appearance space, comprising:
one or more processors; and
one or more media computer-readable having stored thereon executable instructions that when executed by the one or more processors configure the computer system to perform at least the following:
receive a plurality of coating spatial appearance variables of a target coating from a coating-measurement instrument, wherein the plurality of coating spatial appearance variables comprises a graininess variable;
generate target spatial appearance space coordinates for the target coating by mapping each of the plurality of coating spatial appearance variables to an individual axis in a multidimensional coordinate system, wherein:
the graininess variable is mapped to a first axis of the multidimensional coordinate system, and
a second variable is mapped to a second axis of the multidimensional coordinate system;
access a database of spatial appearance space coordinates, wherein the database comprises multiple unique spatial appearance space coordinates in the multidimensional coordinate system associated with different reference coatings;
identify spatial appearance space coordinates associated with a plurality of potentially matching reference coatings from the database of spatial appearance space coordinates;
calculate a spatial-appearance-space distance between the identified spatial appearance space coordinates associated with the potentially matching reference coatings and the spatial appearance space coordinates of the target coating for each of the potentially matching reference coatings;
identify particular spatial appearance space coordinates from the identified spatial appearance space coordinates associated with the plurality of potentially matching reference coatings that are associated with a smallest spatial-appearance-space distance from the spatial appearance space coordinates of the target coating; and
display a visual interface element indicating a particular reference coating that is associated with the particular spatial appearance space coordinates as a proposed spatial appearance match to the target coating.

2. The computer system as recited in claim 1, wherein the second variable comprises at least one of a sparkle area variable or a sparkle intensity variable.

3. The computer system as recited in claim 2, wherein the graininess variable comprises an identified contrast of light/dark irregular patterns exhibited by the target coating when viewed under illumination.

4. The computer system as recited in claim 2, wherein the sparkle area variable comprises an area segment of spots that are more than a threshold level brighter than their immediate surround on an illuminated portion of the target coating.

5. The computer system as recited in claim 2, wherein the sparkle intensity variable comprises a contrast between appearance highlights on particles of a gonioapparent pigment and the particles' immediate surroundings.

6. The computer system as recited in claim 2, wherein calculating the spatial-appearance-space distance between the identified spatial appearance space coordinates associated with the potentially matching reference coatings and the spatial appearance space coordinates of the target coating for each of the potentially matching reference coatings further comprises:
calculating a plurality of distances between the spatial appearance space coordinates for a specific coating selected from the plurality of potentially matching reference coatings and the spatial appearance space coordinates for the target coating on a per angle basis, wherein each of the spatial appearance space coordinates for the specific coating and each of the spatial appearance space coordinates for the target coating are associated with a predetermined set of angles, such that the plurality of distances comprise calculated distances between the spatial appearance space coordinates for the target coating and the identified spatial appearance space coordinates for the specific coating on a per angle basis for each angle within the predetermined set of angles; and
generating the spatial-appearance-space distance between the target coating and the specific coating by calculating a sum of squares of the plurality of distances.

7. The computer system as recited in claim 1, wherein the executable instructions include instructions that are executable to further configure the computer system to:
receive one or more coating color variables of the target coating from the coating-measurement instrument;
map the one or more coating color variables to target color space coordinates within a color space;
identify color space coordinates associated with a plurality of potentially matching color coatings from a database of reference coatings and associated color space coordinates;
calculate a color-space distance between the identified color space coordinates associated with the potentially matching color coatings and the target color space coordinates of the target coating for each of the potentially matching color coatings; and
identify particular color space coordinates from the identified color space coordinates associated with the plurality of potentially matching color coatings that are associated with a smallest color-space distance from the color space coordinates of the target coating.

8. A computer system for mapping coatings to a spatial appearance space, comprising:
one or more processors; and
one or more media computer-readable having stored thereon executable instructions that when executed by the one or more processors configure the computer system to perform at least the following:
receive a plurality of coating spatial appearance variables of a target coating from a coating-measurement instrument, wherein the plurality of coating spatial appearance variables comprises a sparkle area variable;
generate target spatial appearance space coordinates for the target coating by mapping each of the plurality of coating spatial appearance variables to an individual axis in a multidimensional coordinate system, wherein:
the sparkle area variable is mapped to a first axis of the multidimensional coordinate system, and
a second variable is mapped to a second axis of the multidimensional coordinate system;
access a database of spatial appearance space coordinates, wherein the database comprises multiple unique spatial appearance space coordinates in the multidimensional coordinate system associated with different reference coatings;
identify spatial appearance space coordinates associated with a plurality of potentially matching reference coatings from the database of spatial appearance space coordinates;
calculate a spatial-appearance-space distance between the identified spatial appearance space coordinates associated with the potentially matching reference coatings and the spatial appearance space coordinates of the target coating for each of the potentially matching reference coatings;
identify particular spatial appearance space coordinates from the identified spatial appearance space coordinates associated with the plurality of potentially matching reference coatings that are associated with a smallest spatial-appearance-space distance from the spatial appearance space coordinates of the target coating; and
display a visual interface element indicating a particular reference coating that is associated with the particular spatial appearance space coordinates as a proposed spatial appearance match to the target coating.

9. The computer system as recited in claim 8, wherein the second variable comprises at least one of a graininess variable or a sparkle intensity variable.

10. The computer system as recited in claim 9, wherein the graininess variable comprises an identified contrast of light/dark irregular patterns exhibited by the target coating when viewed under illumination.

11. The computer system as recited in claim 9, wherein the sparkle area variable comprises an area segment of spots that are more than a threshold level brighter than their immediate surround on an illuminated portion of the target coating.

12. The computer system as recited in claim 9, wherein the sparkle intensity variable comprises a contrast between appearance highlights on particles of a gonioapparent pigment and the particles' immediate surroundings.

13. The computer system as recited in claim 9, wherein calculating the spatial-appearance-space distance between the identified spatial appearance space coordinates associated with the potentially matching reference coatings and the spatial appearance space coordinates of the target coating for each of the potentially matching reference coatings further comprises:
calculating a plurality of distances between the spatial appearance space coordinates for a specific coating selected from the plurality of potentially matching reference coatings and the spatial appearance space coordinates for the target coating on a per angle basis, wherein each of the spatial appearance space coordinates for the specific coating and each of the spatial appearance space coordinates for the target coating are associated with a predetermined set of angles, such that the plurality of distances comprise calculated distances between the spatial appearance space coordinates for the target coating and the identified spatial appearance space coordinates for the specific coating on a per angle basis for each angle within the predetermined set of angles; and
generating the spatial-appearance-space distance between the target coating and the specific coating by calculating a sum of squares of the plurality of distances.

14. The computer system as recited in claim 8, wherein the executable instructions include instructions that are executable to further configure the computer system to:
receive one or more coating color variables of the target coating from the coating-measurement instrument;
map the one or more coating color variables to target color space coordinates within a color space;
identify color space coordinates associated with a plurality of potentially matching color coatings from a database of reference coatings and associated color space coordinates;
calculate a color-space distance between the identified color space coordinates associated with the potentially matching color coatings and the target color space coordinates of the target coating for each of the potentially matching color coatings; and
identify particular color space coordinates from the identified color space coordinates associated with the plurality of potentially matching color coatings that are associated with a smallest color-space distance from the color space coordinates of the target coating.

15. A computer system for mapping coatings to a spatial appearance space, comprising:
one or more processors; and
one or more computer-readable media having stored thereon executable instructions that when executed by the one or more processors configure the computer system to perform at least the following:
receive a plurality of coating spatial appearance variables of a target coating from a coating-measurement instrument, wherein the plurality of coating spatial appearance variables comprises a sparkle intensity variable;
generate target spatial appearance space coordinates for the target coating by mapping each of the plurality of coating spatial appearance variables to an individual axis in a multidimensional coordinate system, wherein:
the sparkle intensity variable is mapped to a first axis of the multidimensional coordinate system, and
a second variable is mapped to a second axis of the multidimensional coordinate system;
access a database of spatial appearance space coordinates, wherein the database comprises multiple unique spatial appearance space coordinates in the multidimensional coordinate system associated with different reference coatings;
identify spatial appearance space coordinates associated with a plurality of potentially matching reference coatings from the database of spatial appearance space coordinates;
calculate a spatial-appearance-space distance between the identified spatial appearance space coordinates associated with the potentially matching reference coatings and the spatial appearance space coordinates of the target coating for each of the potentially matching reference coatings;
identify particular spatial appearance space coordinates from the identified spatial appearance space coordinates associated with the plurality of potentially matching reference coatings that are associated with a smallest spatial-appearance-space distance from the spatial appearance space coordinates of the target coating; and
display a visual interface element indicating a particular reference coating that is associated with the particular spatial appearance space coordinates as a proposed spatial appearance match to the target coating.

16. The computer system as recited in claim 15, wherein the second variable comprises at least one of a graininess variable or a sparkle area variable.

17. The computer system as recited in claim 16, wherein the graininess variable comprises an identified contrast of light/dark irregular patterns exhibited by the target coating when viewed under illumination.

18. The computer system as recited in claim 16, wherein the sparkle area variable comprises an area segment of spots that are more than a threshold level brighter than their immediate surround on an illuminated portion of the target coating.

19. The computer system as recited in claim 16, wherein the sparkle intensity variable comprises a contrast between appearance highlights on particles of a gonioapparent pigment and the particles' immediate surroundings.

20. The computer system as recited in claim 16, wherein calculating the spatial-appearance-space distance between the identified spatial appearance space coordinates associated with the potentially matching reference coatings and the spatial appearance space coordinates of the target coating for each of the potentially matching reference coatings further comprises:
calculating a plurality of distances between the spatial appearance space coordinates for a specific coating selected from the plurality of potentially matching reference coatings and the spatial appearance space coordinates for the target coating on a per angle basis, wherein each of the spatial appearance space coordinates for the specific coating and each of the spatial appearance space coordinates for the target coating are associated with a predetermined set of angles, such that the plurality of distances comprise calculated distances between the spatial appearance space coordinates for the target coating and the identified spatial appearance space coordinates for the specific coating on a per angle basis for each angle within the predetermined set of angles; and
generating the spatial-appearance-space distance between the target coating and the specific coating by calculating a sum of squares of the plurality of distances.
